(19) United States
(12) Patent Application Publication
(10) Pub. No.: US 2006/0195875 A1
(43) Pub. Date: Aug. 31, 2006

(54) Method and equipment for distributing digital video products with a restriction of certain products in terms of the representation and reproduction rights thereof

(75) Inventor: Daniel LeComte, Paris (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Medialive, Paris (FR)

(21) Appl. No.: 10/551,921

(22) PCT Filed: Apr. 9, 2004
(86) PCT No.: PCT/FR04/50153

§ 371 Date: Oct. 5, 2005

(30) Foreign Application Priority Data
Apr. 11, 2003 (FR) 0350098

(51) Int. Cl. H04N 7/173

(52) U.S. Cl. 725/105

(57) ABSTRACT

A process for distributing digital video products with a restriction of at least certain rights of representation and reproduction, including an initial stage of forming a bank of original digital video sequences on a publicly inaccessible server for each request made by a user, and a stage of selection by the user of one or several sequences of the video bank, which selection stage activates a modification stage producing a modified main stream in a nominal format of a selected original video sequence, but whose content was modified by cutting into two parts, a larger part of which is recorded in the modified main stream that cannot be used on standard reading equipment, and a smaller part that is retained in the server within complementary digital information personalized for each user and complementary to the modified main stream, a stage for transmitting the main stream modified at a distribution site, a stage for recording the modified main stream at the distribution site on a standardized support material, and a stage of sending complementary digital information to the user during viewing of the modified main stream sent to the user on the material support supplied by the distributor.

The present invention relates to the area of the distribution of audiovisual content via a physical distribution system such as an automaton [automatic installation] for the renting of DVD's or video cassettes. The present invention relates more particularly to a means of securing the distribution of an audiovisual content on a physical support such as a DVD, with limited exploitation rights, and using the characteristics of the video compression format. The invention relates, without being limiting, in particular to the MPEG-2 video compression format, used in particular in DVD's.

The present invention proposes to supply a system that permits a digital video content distributed physically to the user to be visually scrambled and recomposed. The invention proposes a system that permits the user to have at his disposal non-scrambled video content in exchange for a transaction predefined by the distributor or to be defined at the moment of viewing the audiovisual content. The invention also permits a total control of the use of copies and of the rights of broadcast works.

Certain current solutions permit the distribution of physical audiovisual supports of the DVD type via an automatic distributor or a rental store. Even if it is not authorized, the DVD disks rented to the user can be used by the latter for being copied during the rental time because they contain all the information necessary to make a copy of them. Moreover, it can occur in the stock of films preserved by a distributor that a film is not available for a client who desires it.

In order to avoid non-authorized pirated use, certain solutions propose transmitting to the user an audiovisual stream that is scrambled, encrypted and/or protected by one or several coding keys. The descrambling is conditioned by one or several descrambling keys that is/are sold in exchange for a transaction. The problem in this type of the solution is that a user equipped with powerful tools can determine the descrambling key or keys without making the transaction and thus obtain a descrambled stream that he can use as desired, either for viewing it in an illicit manner or for making pirated copies of it.

In order to correct these various deficiencies the invention relates in accordance with its most general meaning to a process for the distribution of digital video products with a restriction of at least certain rights of representation and of reproduction, characterized in that it comprises an initial stage of the constitution of a bank of original digital video sequences on a server inaccessible to the public, and for each request made by a user and for selection stages by the user of one or several sequences of this video bank this selection stage activates the transmission of the video sequence in the nominal format of the original video sequence selected but of which the content was modified in order to render it non-usable on standard reading equipment, and comprises the recording of a second piece of personalized information for this user and complementary to said first sequence, which first sequence is recorded at the distribution site on a standardized support material, and that the second piece of information is delivered to the user during the viewing of this modified video sequence sent to the user on this support material supplied by the distributor.

According to a first variant this transmission stage of this modified video sequence also comprises a stage of storing digital information that identifies the distributor.

According to a second variant this first part contains said digital information identifying the distributor.

The process advantageously comprises an additional stage of reading this support by an apparatus comprising a means of identifying said user.

According to an advantageous embodiment the selection stage is realized by the user from a personal terminal of the user communicating with the video server by a public telecommunication network. The terminal can be a personal computer communicating with the video server via the Internet, or a dedicated terminal such as a MINITEL (trademark) or also a cellular telephone via SMS, WAP, or a voice server or a telephone using DTMF commands.

According to a variant the recording of this first sequence at the distribution site is conditioned by the transmission by the user of identifying information.

This identifying information can be constituted by information transmitted during the selection and the payment of the sequence in the form of a message sent by electronic mail or by SMS, or also by the credit card number used for making the payment at the moment of the selection or during the removal of the support from the distributor.

The invention also relates to a system for the distribution of digital video sequences comprising a video server, characterized in that it also comprises at least one piece of distribution equipment comprising a means for recording a video sequence transmitted by this server on a physical support, and means for identifying a user by this video server on the one hand and the distribution equipment on the other hand.

The distribution equipment is advantageously constituted by an automaton comprising a DVD burner and conditional means of accessing the burned DVD by the user who selected the corresponding video sequence from the video server.

The present invention will be better understood from a reading of the following description of a non-limiting exemplary embodiment referring to the attached drawing in which FIG. 1 describes the total architecture of a system for carrying out the process in conformity with the invention.

The general principle of a process for securing a video stream is disclosed in the following. The objective is to authorize the video services on demand and a la carte [separately] via all broadcasting networks and to authorize the local recording in the digital decoder box of the user. The solution consists in permanently retaining a part of the recorded audiovisual program away from the audiovisual decoder of the user and in fact in the broadcasting and transmitting network, which part is of primary importance for viewing said audiovisual program on a television screen or on a monitor-type screen but has a very small volume relative to the total volume of the digital audiovisual programs stored with the user. The lacking part is transmitted via the transmitting broadcasting network at the moment of the viewing of this digital audiovisual program prerecorded at the user's.

The greatest part of the audiovisual stream is recorded on a classic support of video content (CD-ROM, DVD, etc.), which support must, however, store the information in digital form. The support is sold, distributed free of charge or is loaned to the user and can be read by a classic device for reading this type of support (CD reader and/or DVD reader). Alternatively, the greatest part of the audiovisual stream is transmitted via a classic broadcasting network.

The lacking part is sent on demand via a narrow band telecommunication network such as the classic telephone networks or the cellular networks of the GSM, GPRS or UMTS type or by using a small part of a network of the DSL or BLR type, or also by using a subset of the bandwidth shared on a cable network. The lacking part is sent as the viewing of the video stream progresses and is stored temporarily in a volatile memory of the client equipment. Thus, it can not be recopied by the user after it has been used for viewing.

Thus, the user never has the entire original video stream in digital form on his equipment and can therefore not reproduce it illegally. In the remainder of the text the greatest part, distributed onto a support for the user, is called “modified main stream.” The lacking part is called “complementary digital information.”

In FIG. 1 the video distribution automaton 3 is adapted for connecting at least one display device, e.g., a monitor, a video projector or a device like a television screen 4 to at least one interface of a transmission and broadband broadcasting network 7 and to at least one telecommunication network interface 6. According to the present invention this arrangement is composed of a decoder module 3 comprising primarily, on the one hand, a processing unit adapted for processing, in particular decoding and descrambling any digital video stream according to a pre-loaded software program of decoding and descrambling in such a manner as to display it, in real or differed time [time shift viewing], store it, record it and/or send it on a telecommunication network, and comprising on the other hand at least one screen interface 4 and an interface for connecting to a local or extended network 6 and/or 7. The broadband transmission and broadcasting network 7 and the telecommunication network 6 can be combined in a single network. Moreover, the broadband transmission and broadcasting network 7 can be replaced by a physical distribution channel (e.g., CD-ROM or DVD).

As FIG. 1 shows, distribution automaton 3 is connected to broadband transmission and broadcasting network 7 such as a modem, satellite modem, cable modem, fiber optic line interface or radio or infrared interface for wireless communication.

The content of audiovisual program such as films or any other audiovisual or multimedia sequence will be sent by this classic video broadcasting link. However, in order not to allow pirated copies to be made, provision is made prior to transmitting the audiovisual content from server 1 to retain a small part of the audiovisual content in this server 1. Likewise, if the audiovisual content is distributed by a physical support such as a disk 22 and not solely via a broadband transmission and broadcasting network 7, a small part of the audiovisual content is removed from the latter before it is recorded on this support 22.

In the case in which an audiovisual program is viewed in real time, this small part of the audiovisual content retained in server 1 will also be sent to module 3 via telecommunication network 6. Alternatively, this small part of the audiovisual content retained in server 1 will be transmitted to module 3 by a physical support such as a memory card.

The present invention will be better understood from a reading of an exemplary embodiment referring to the attached drawing. In this exemplary embodiment the audiovisual content undergoes a first analysis stage. Entering digital audiovisual stream 10 is sent to analysis device 11 that uses the characteristics of the video coding format of stream 10 in order to determine modified main stream 101 and complementary digital information 102. Modified main stream 101 has the same format as entering stream 10 but has undergone modifications to certain parameters. The modified main stream can therefore by read on a standard reader of this format but the displaying of the corresponding audiovisual content is not correct from the standpoint of human perception. In the case of MPEG-2 the modifications made to entering stream 10 can be: Modification or substitution of certain DC coefficients of certain blocks, modification or substitution of information about the compensation of movement, modification or substitution of the order of scanning coefficients of certain images, etc.

The modifications made and any original information replaced in modified main stream 101 are stored in complementary digital information 102 in order to be subsequently sent to the user of the equipment 3.

In the exemplary embodiment described in the following modified main stream 101 is transmitted to an automaton for the distribution of supports of video streams via link 5. Modified main stream 101 is recorded on hard disk 21 of distributing automaton 2. Link 5 between equipment 2 and analyzing server 1 can be a telecommunication link such as a DSL, BLR or cable link. Alternatively, modified main stream 101 is recorded on a physical support that equipment 2 can read such as, e.g., a DVD.

A user who has client equipment 3 goes to the distributor with equipment 2. He requests original video stream 10 from this distributor. The distributor then uses equipment 2 for burning a physical support 22 containing modified main stream 101 stored in memory 21. Automaton 2 advantageously records an identifier of this distributor comprehensible to server 1 on physical support 22. Physical support 22 therefore contains modified main stream 101 and an identifier of distributor 2. According to the distributor the supplying of physical support 22 to the client can be or not be the subject of a transaction.

In the instance in which modified main stream 101 is not stored in memory 21, modified main stream 101 is advantageously transmitted by server I to automaton 2 via link 5.

The user then inserts physical support 22 into reader 32 of his client equipment 3. When he desires to view original video stream 10 he can not do so without recovering complementary digital information 102. For this, client equipment 3 is connected to server 1 by link 6. Server 1 identifies client equipment 3 by a classic system of terminal identification (IP address, smart card, number of telecommunication line 6, etc.). According to a transaction between user 3 and the company managing server 1, the latter either authorizes or does not authorize the sending of complementary digital information 102 to client equipment 3 via network 6.

Furthermore, before the start of viewing, client equipment 3 automatically sends the identifier of distributor 2 contained on physical support 22 to server 1. Thus, server 1 recognizes the origin of physical support 22 on the client equipment and could pay distributor 2 via a subsequent transaction not described in the invention.

Complementary digital information 102 is sent to client equipment 3 as video stream 22 is being viewed and read itself by reader 32 of client equipment 3. To this end digital information 102 is sent via network 6 and is stored temporarily in volatile memory 31 of equipment 3. Synthesis device 35 receives the portion of complementary digital information via buffer 33 and the portion of the modified main stream to be displayed stored on disk 22 in reader 32 via buffer memory 34. Synthesis device 35 reconstitutes from complementary digital information 102 and modified main stream 101 a stream that is strictly identical to original stream 10 and transmits it to classic decoder 36 with the format of the original stream. The decoded stream is displayed on viewing screen 4.

The embodiment described above comprises a large number of variants, presented below.

The format of physical support 22 of the modified main stream is advantageously in the DVD format.

The video format of the streams concerned is advantageously different from the MPEG-2 format used by current commercial DVD's.

Another embodiment of the present invention advantageously consists in applying a different analysis for each distributor 2. Then, the original stream 10 is cut in two for each distributor 2 by analysis device 11. Server 12 is then connected to a database in which each different analysis is associated with an identifier of distributor 2 to which the resulting modified main stream is transmitted. Thus, when client equipment 3 requests complementary digital information 102, the file requested allows the distributor to be determined that supplied the modified main stream to the user and thus allows a transaction to be made with the identifier of distributor 2.

Server 1 and distribution automaton 2 are advantageously integrated into automatic server equipment 8.

Several users 3 can advantageously view the same audiovisual file 10 via the same physical support 22. The disk is available at a distributor such as a renter of DVD's. The disk can be borrowed by clients of this distributor 2 in order to be viewed on adequate equipment 3. Disk 22 contains modified main stream 101 and the address of this distributor 2. When the user borrows the disk at this distributor and desires to view the video content, he has two possibilities:
Either the user looks at the video content such as it is recorded on disk 22, but since modified main stream 101 is strongly degraded from the standpoint of human visual perception, he can not view the film,
Or, if user 3 really desires to view the original video stream, he is automatically connected to server 1 in order to obtain complementary digital information 102. To this end, user 3 establishes connection 6 with server 1, which connection can be an RTC link, DSL link, cable link, etc. Server 1 sends complementary digital information 102 as the viewing of the video stream progresses. Complementary digital information 102 is stored temporarily in input memory 31, that is a volatile memory. Synthesis device 35 receives the complementary digital information stored in buffer 33 and the modified main stream stored on disk 32 inserted in equipment 3 via reading buffer 34. Synthesis device 35 uses the information contained in complementary digital information 102 for correcting the modified main stream in order to reconstitute a video stream identical to original stream 11. The reconstituted video stream is sent to classic audiovisual decoder 36 and is displayed on viewing means 4.

Server 1 is advantageously integrated into distributor automaton 2.

Each modified main stream 101 and each complementary digital information 102 is advantageously personalized for each user 3.

Device 8 advantageously records complementary digital information 102 on physical support 23 such as a flash memory card or any other means of portable storage, which permits the recomposition of the original stream 11 by equipment 3 without equipment 3 necessarily being connected to a transmission network 6, which physical support 23 is then connected via memory 31 to interface 33 of module 8 for the reconstitution of the original stream.

Device 8 advantageously records on physical support 23 the number of times that the original stream corresponding to complementary digital information 102 can be viewed.

The same physical support 23 can advantageously comprises several files of complementary digital information 102.

Device 8 advantageously records modified main stream 101 and complementary digital information 102 on physical support 22, thus permitting the creation of a private copy of the stream to be recomposed in conformity with original stream of 11, which recomposition is made by equipment 3.

Device 8 advantageously records original stream of 11 on physical support 22, thus permitting the creation of a private copy of this original stream of 11.

Automaton 2 advantageously comprises means for printing labels and jackets to be placed on physical support 22 and the box of physical support 22.

1-20. (canceled)

21. A process for distributing digital video products with a restriction of at least certain rights of representation and reproduction, comprising:
an initial stage of forming a bank of original digital video sequences on a publicly inaccessible server for each request made by a user, and
a stage of selection by the user of one or several sequences of the video bank, which selection stage activates
a modification stage producing a modified main stream in a nominal format of a selected original video sequence, but whose content was modified by cutting into two parts, a larger part of which is recorded in the modified main stream that cannot be used on standard reading equipment, and a smaller part that is retained in the server within complementary digital information personalized for each user and complementary to the modified main stream,
a stage for transmitting the main stream modified at a distribution site,
a stage for recording the modified main stream at the distribution site on a standardized support material, and
a stage of sending complementary digital information to the user during viewing of the modified main stream sent to the user on the material support supplied by the distributor.

22. The process according to claim 21, wherein the transmission stage of the modified main stream further comprises a stage of storing digital information that identifies the distributor.

23. The process according to claim 22, wherein the modified main stream contains digital information identifying the distributor.

24. The process according to claim 21, wherein the support is a DVD disk.

25. The process according to claim 21, further comprising a stage of reading the support with an apparatus comprising a user identifier.

26. The process according to claim 21, wherein the selection stage is realized by the user from a personal terminal of the user communicating with the video server by a public telecommunication network.

27. The process according to claim 21, wherein the stage of recording the modified main stream at the distribution site is conditioned by transmission by the user of identifying information.

28. The process according to claim 21, wherein the stage for modifying the original video sequence corresponds to a processing specific to the distributor designated by the user during the selection stage.

29. The process according to claim 28, wherein the server is connected to a database in which each specific processing is associated with an identifier of the distributor to which a resulting modified main stream is transmitted.

30. The process according to claim 21, wherein during use of the physical support obtained from the distributor, the user establishes a connection with the server, which sends the complementary digital information as viewing of the video stream progresses, which portion of complementary digital information is stored temporarily in an input memory that is a volatile memory.

31. The process according to claim 30, wherein the synthesis device receives the complementary digital information stored in a buffer and the modified main stream stored on a disk inserted in the equipment via a reading buffer, and the synthesis device uses information contained in the complementary digital information to modify the modified main stream to reconstitute a video stream identical to the original stream.

32. The process according to claim 21, wherein the stage of modifying the original video sequence corresponds to a processing specific for each user identified during the selection stage.

33. The process according to claim 32, wherein the server is connected to a database in which each specific processing is associated with a user.

34. The process according to claim 21, wherein the device records on a portable storage the complementary digital information that permits recomposition of the original stream by equipment without the equipment necessarily being connected to a transmission network, and a physical support is then connected to an interface of a module for reconstitution of the original stream.

35. The process according to claim 21, wherein the client equipment comprises a counter of a number of possible representations.

36. A system for distributing digital video sequences comprising: a video server that carries out the process according to claim 21, at least one piece of distribution equipment comprising a video sequence recorder transmitted by the server on a physical support, and a user identifier by the video server and the distribution equipment.

37. The system according to claim 36, wherein the distribution equipment comprises an automaton/device comprising a DVD burner and conditional means of accessing the burned DVD by the user who selected a corresponding video sequence from the video server.

38. The system according to claim 36, wherein the distribution equipment and the server are locally interconnected without a link via a telecommunication network.

39. The system according to claim 36, wherein the distribution equipment comprises a printer to print an information product.

40. The system according to claim 36, wherein the distribution equipment comprises an automaton/device for distribution of recording supports.
